(19) United States
(12) Patent Application Publication
(10) Pub. No.: US 2012/0182725 A1
(43) Pub. Date: Jul. 19, 2012

(54) LIGHTING APPARATUS AND ENCLOSURE

(76) Inventor: Thomas Christopher King, Knoxville, TN (US)

(21) Appl. No.: 13/183,116

(22) Filed: Jul. 14, 2011

Related U.S. Application Data
(60) Provisional application No. 61/365,053, filed on Jul. 16, 2010.

(51) Int. Cl. F21L 4/02; B23P 17/04

(52) U.S. Cl. 362/183; 29/401.1

(57) ABSTRACT

An autonomous lighting apparatus for use in an interior of an enclosure having a barrier including a translucent portion. The lighting apparatus is attached to an interior side of the translucent portion of the barrier and includes a solar cell configured to receive light energy directed through the translucent portion. The lighting apparatus also includes a rechargeable power storage apparatus electrically engaged with the solar cell, a light source electrically engaged with the power storage apparatus, and a detection device detection device electrically engaged with the power storage apparatus and configured to detect events occurring in the interior of the enclosure, such that upon the detection of such events the light source is activatable to illuminate the interior of the enclosure.

### BACKGROUND

It is common at construction sites, concerts, festivals and other large outdoor gathering, to use portable toilets to provide temporary toilet facilities. These portable toilets are typically portable, self-contained outhouses manufactured of molded plastic and designed for single occupancy. Portable toilets are typically free-standing structures with a waste tank located in their lower portion and without connection to electricity or plumbing. While portable toilets provide a convenient means of sanitation at remote and/or outdoor areas, they also face certain disadvantages due to, for example, the lack of electricity. Among other things, a typical portable toilet is solely reliant on ambient lighting from the sun, street lights, and the like to provide lighting to occupants. This can limit usability in nighttime situations where there is no or insufficient ambient light available to an occupant. Accordingly, there is a need for a light source for portable toilets and other similar enclosures which does not rely on external power sources. Furthermore, there is a need to provide a quick and convenient retrofit for existing portable toilets and similar enclosures to provide such a light source.

Others have attempted to manufacture portable enclosures including a solar-powered light by creating an aperture through the roof of the enclosure such as, for example, the disclosure of U.S. Pat. No. 6,402,338 entitled “Enclosure Illumination System” to William P. Mitzel et al. However, this has proven to be undesirable for a number of reasons including, but not limited to, the creation of potential leaking through the roof of a portable enclosure, the destruction of an exposed solar cell due to inclement weather conditions and during common aggressive washing certain portable enclosures undergo (i.e., portable toilets), and weakening the overall structural integrity of the enclosure. Additionally, the system requires alteration of the enclosure to create an aperture in the enclosure for placement of the lighting system, which is especially inconvenient and nonconducive to retrofitting existing enclosures. Accordingly, there remains a need for an improved lighting system for use with portable toilets and similar enclosures.

### SUMMARY

The above and other needs are met by an autonomous lighting apparatus for use in an interior of an enclosure having a barrier including a translucent portion. The lighting apparatus includes a casing with a base having a first side and a second side. A solar cell is configured to receive light energy directed toward the first side of the base. An adhesive is disposed adjacent the first side of the base for attaching the first side of the base to an interior side of the translucent portion of the barrier. A removable liner may be disposed on the adhesive and the adhesive may be a piece of double-sided foam with adhesive layers on both sides thereof. A rechargeable power storage apparatus, such as a rechargeable battery, is electrically engaged with the solar cell and a light source, such as a light bulb or LED, is electrically engaged with the power storage apparatus. A detection device is adjacent the second side of the base and configured to detect events occurring in the interior of the enclosure, such that upon the detection of such events the light source is activatable to illuminate the interior of the enclosure.

The detection device may be an infrared sensor or a light sensor capable of detecting changes in light levels. The lighting apparatus may be configured such that when the detection device detects that ambient light levels have reached a threshold level, the light source is activated to illuminate the interior of the enclosure. The lighting apparatus may also be configured to activate the light source or increase the intensity of the light source upon detection in a sudden change in light levels, cause by, for example, a person entering the enclosure or opening a door to the enclosure. The lighting apparatus may have multiple modes of operation. In one embodiment, a reed switch is provided for toggling between the modes by application of a magnet adjacent the casing.

A translucent cover may be attached to the base for protecting the internal components of the lighting apparatus. At least one o-ring may be disposed at the interface between the base and the cover to make the lighting apparatus substantially water-tight.

The lighting apparatus may be used to retrofit existing enclosures, such as a portable toilet, by, for example, adhering the lighting apparatus to a translucent portion of the roof Since the solar cell receives light energy through the translucent portion, there is no need to create an aperture in the roof.

### BRIEF DESCRIPTION OF THE DRAWINGS

Further features, aspects, and advantages of the present disclosure will become better understood by reference to the following detailed description, appended claims, and accompanying figures, wherein elements are not to scale so as to more clearly show the details, wherein like reference numbers indicate like elements throughout the several views, and wherein:

FIG. 1 shows a somewhat schematic perspective view of an embodiment of a lighting apparatus;

FIG. 2 shows a somewhat schematic perspective view of the lighting apparatus of FIG. 1 shown at a flipped orientation;

FIG. 3 shows a schematic view of an embodiment of circuitry that may be used with the lighting apparatus shown in FIGS. 1-2;

FIG. 4 shows a somewhat schematic perspective view of another embodiment of a lighting apparatus;

FIG. 5 shows a somewhat schematic perspective view of an embodiment of an enclosure including a lighting apparatus;

FIG. 6 shows a somewhat schematic perspective view of another embodiment of an enclosure including a lighting apparatus;

FIG. 7 shows an exploded view of an embodiment of a casing for a lighting apparatus; and

FIG. 8 shows a perspective view of the lighting apparatus show in in FIG. 7.

### DETAILED DESCRIPTION

Various terms used herein are intended to have particular meanings. Some of these terms are defined below for the purpose of clarity. The definitions given below are meant to cover all forms of the words being defined (e.g., singular, plural, present tense, past tense). If the definition of any term below diverges from the commonly understood and/or dictionary definition of such term, the definitions below control.

Electrically engaged: connotes the relationship between a first object and a second object whereby electricity may flow from the first object to the second object (or vice versa) under certain conditions (e.g., if there is an electrical potential between the first object and the second object, if there are no open switches between the first object and the second object).

Electrical pathway: a zone through which electricity is anticipated to flow under certain conditions (e.g., if there is an electrical potential between the first object and the second object, if there are no open switches between the first object and the second object).

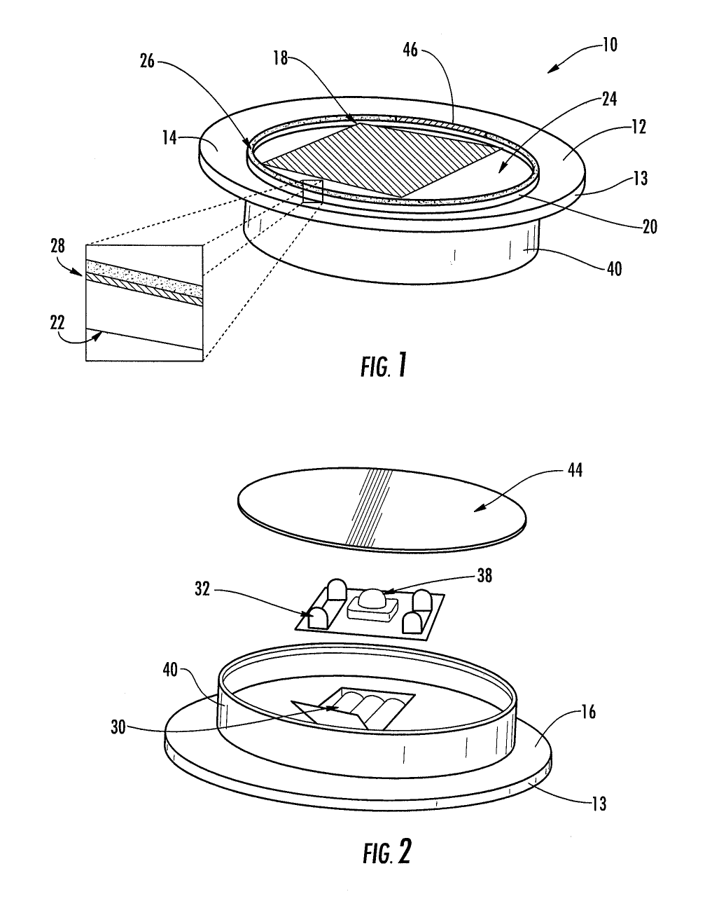

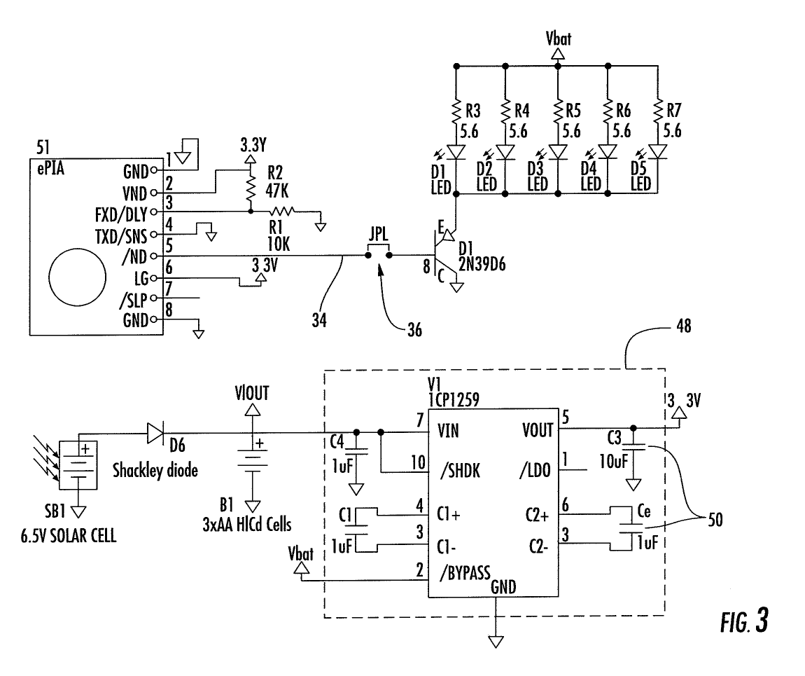

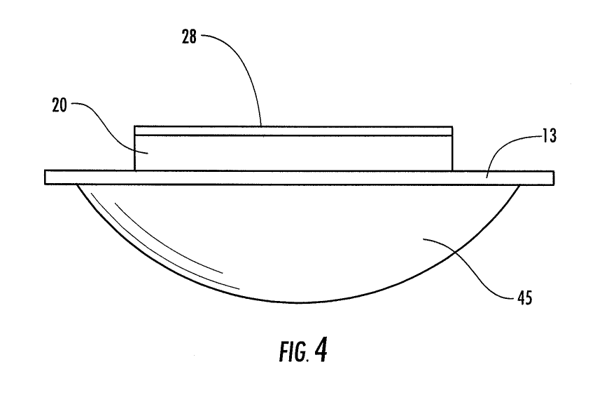

FIGS. 1-2 depict a basic embodiment of a lighting apparatus 10 for use in the interior of an enclosure including a wall, roof, or other barrier member with a translucent portion. The lighting apparatus 10 includes a casing 12 including a base 13 having a first side 14 and a second side 16; a solar cell 18 attached adjacent the first side of the base 14; a spacer 20 including a first spacer surface 22, a central aperture 24 in which the solar cell 18 is located, and a second spacer surface 26, the second spacer surface 26 including an adhesive layer 28; a rechargeable power storage apparatus 30 electrically engaged with the solar cell 18; a light source 32 electrically engaged with the power storage apparatus 30; and a detection device 38 attached adjacent the second side of the base 16 wherein, in response to the detection of a detection event by the detection device 38, the light source 32 is caused to illuminate.

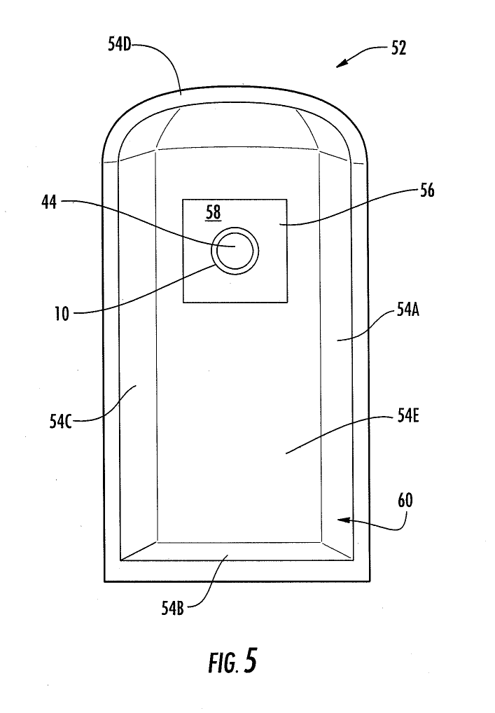

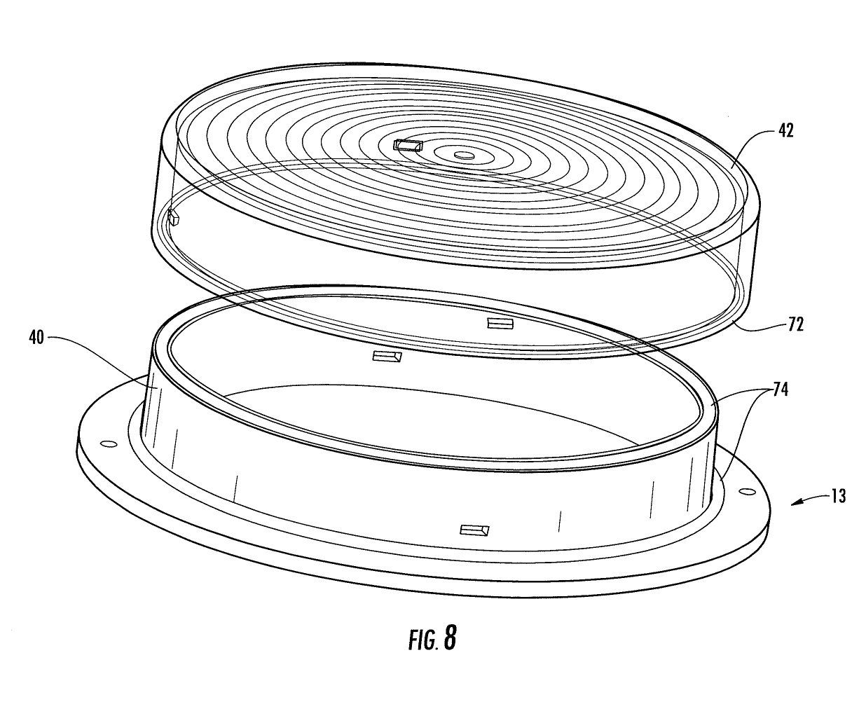

In one embodiment, shown in FIGS. 1-2, the lighting apparatus 10 also includes a cylindrical wall 40 extending substantially orthogonal to the second side of the base 16. In this embodiment, a translucent cover 42 is preferably attached adjacent the wall 40 at least in part to protect the detection device 38 from the elements. In a related embodiment shown in FIG. 4, the casing 12 has no walls 40, so a cover 45 is attached adjacent the base 13 directly. In a further preferred embodiment is shown in FIGS. 7-8, the casing 12 is substantially water-tight. The base 13 includes a cylindrical wall 40 with a groove 70 in the upper surface of the wall. A translucent cover 42 is in a snap-fit relationship with the wall 40 of the base 13. The cover 42 includes a groove 72 formed on the interior of its lower lip. Two o-rings 74 are disposed in the grooves 70 and 72 to provide a substantially water-tight seal between the base and cover. A water-tight seal is important because portable toilets are often cleaned with high pressure water jets and the internal components of the lighting apparatus can be damaged if water encroaches into the interior of the apparatus.

The spacer 20 is preferably a resilient elastomeric material, such as a foam material. However, in certain embodiments the spacer may be a hard plastic material or there may be no spacer and the adhesive layer 28 may be disposed on the second side of the base. Preferably, a removable liner 46 is attached adjacent the adhesive layer 28, wherein the liner 46 is preferably fully removed before attachment of the lighting apparatus 10 to a translucent surface. FIG. 1 shows part of the 46 liner covering a portion of the adhesive layer 28. In one embodiment, the spacer 20, adhesive layer 28, and liner 46 are provided in the form of double-sided foam tape having a thickness ranging from about 0.25 inches to about 0.5 inches which is available, for example, from 3M (4004 Permabond™ series double sided tape). One side of the foam tape is adhered to the first side of the base and the other side of the foam tape provides the adhesive layer and liner. In certain alternate embodiments, screw or rivet holes may also be included in the casing and/or replace the adhesive layer, in order to allow for substantially permanent attachment to an enclosure.

In one embodiment, for example, the rechargeable power storage apparatus 30 includes a rechargeable battery, such as three AAA rechargeable batteries. The batteries are preferably nickel-cadmium batteries. The lighting apparatus 10 may include a logic module 48 including a plurality of capacitors 50 for trickle charging the rechargeable battery or batteries. The batteries preferably provide from about 2.4 to about 4.8 volts (most preferably, about 3.6 volts) at from about 900 to about 1100 mA·h.

As noted above, a solar cell 18 preferably recharges the power storage apparatus 30. The solar cell 18 is preferably a standard photovoltaic cell capable of producing at least about 12 mA at full sunlight and preferably rated at about 6.5 volts and no lower than about 1.2 volts. However, any solar cell capable of providing sufficient power to the lighting apparatus 10 may be used. In certain embodiments, the solar cell is disposed on the first side 14 of the base 13 to receive light energy directed onto the first side of the base. However, in alternate embodiments, the base 13 is translucent and the solar cell 18 is disposed on the second side 61 of the base 13, but directed toward the first side 14 to receive light energy passing through the translucent base. This alternate embodiment allows the solar cell 18 to remain on the interior of the casing 12 and benefit from the water-tightness of the casing 12.

In one embodiment, the light source 32 includes one or more light emitting diodes (LED), preferably about four LEDs to provide sufficient light output. Each LED preferably has a maximum intensity of from about 20 to about 25 candelas. It is also preferable that the light source 32 draw about 100 mA of current and preferably no more than about 250 mA. In alternate embodiments, the light source 32 may be a standard light bulb or other source of illumination.

In one embodiment, for example, the detection device 38 includes an infra-red motion detector. However, in a preferred embodiment, the detection device 38 is a light sensor which detects light levels and changes in such levels. In certain embodiments, it may be preferable to encircle the detection device with a cylindrical shroud to limit the detection of light and/or infra-red emissions from the light source 32. Furthermore, in certain embodiments, the light source may be configured to turn off for a short period of time, such as a half second, at set intervals, such as every 30 seconds, to allow the detection device 38 to obtain a correct reading of ambient light levels.

In one embodiment, the light source 32 is electrically engaged with the power storage apparatus 30 via an electrical pathway 34 including a switch 36. The detection device 38 may be configured such that when the light/infrared level reaches a certain threshold level, the switch 36 closes in response to the detection of the threshold light level, thereby causing electricity to flow through the light source 32 and causing the light source 32 to illuminate. However, in a preferred embodiment, an integral microprocessor monitors the light/infrared levels detected by the detection device 38 and manages power to the light source 32, allowing for variable light output in response to various light levels. For example, the microprocessor may be configured to provide several modes of operation for the lighting apparatus 10.

A first mode may be a standard mode, wherein, when the detected light levels fall below a first threshold level, the light source 32 is turned on, and when the detected light level is above the threshold level, the light source is turned off. The threshold level may be, for example, a light level consistent with an ambient, outdoor light level at night.

A second mode may be a motion detection mode which detects and responds to changes in light level. The microprocessor may be configured to switch the lighting apparatus 10 to operate in the second mode at dim light levels. In certain embodiments, this could be done automatically. At a second threshold level, such as dim light situations under a street light or at dusk, the light source may be configured to turn on only when sudden changes in light level are detected. For example, if the door to an enclosure is opened and the light level changes, the light source 32 would be turned on for a set period of time, such as two minutes. However, if no changes in light level are detected, the light source 32 remains off to conserve power.

A third mode may operate such that, in addition to detecting whether a light level has reached a threshold level, the lighting apparatus is also configured to vary light output in response to certain events. For example, in the third mode, the light source 32 may be turned on to output light at 50% of a maximum level when the detected light levels fall below a threshold level. However, when the enclosure is entered, the detection device 38 detects a change in light level, such as due to varying reflection of light off of the person entering the enclosure and/or light entering from outside of the enclosure, and the light source is brightened for added visibility.

A fourth mode may be a motion/light detection mode which operates to extend battery life. In this mode, the lighting apparatus may operate similarly to its operation in the second mode, but with light output provided by the light source at approximately 50% of maximum output. This mode may be desirable to extend battery life, such as in situations where solar levels are low and unable to fully recharge the power storage apparatus 30.

In certain embodiments, the microprocessor may be configured to automatically switch between modes at certain light levels or due to other predefined events. In other embodiments, the mode may be changed by a user, such as by operation of a manual switch. However, in a preferred embodiment, a magnetically operated reed switch is usable to change between modes of operation. A permanent magnet may be provided in conjunction with the lighting apparatus which a user may place against the lighting apparatus casing 12 to operate the reed switch. For example, the magnet may be placed against the casing to turn on the lighting apparatus 10. This may be indicated to a user by the light source flashing once to show that the lighting apparatus is powered on in the first mode. The magnet may then removed from the casing and replaced against the casing as necessary to toggle to the second mode, third mode, etc. which may be indicated to the user by the light source flashing twice, thrice, etc., respectively. A reed switch, rather than a manual switch, is preferable in order to preserve the water-tight quality of the lighting apparatus 10, since no external aperture is required to allow operation of the switch, as would be necessary with a manual switch. The microprocessor may use non-volatile memory to store the last initiated mode, so that battery removal or full discharge will not cause the system to lost track of the programmed mode of operation.

As noted above, in a preferred embodiment, the lighting apparatus 10 is preferably used on the interior of enclosures with a translucent roof, wall, or other barrier member. For example, FIG. 5 which shows an enclosure 52 including a plurality of substantially nonporous and stiff barriers 54A, 54B, 54C, 54D, and 54E. At least one of the barriers—in this case 54E, a sidewall of the enclosure—includes a translucent portion 56. The barrier 54E includes a first barrier side 58 oriented toward an interior section 60 of the enclosure apparatus 52. The enclosure apparatus 52 further includes a lighting apparatus 10. The adhesive layer 28 is attached adjacent the first barrier side 58 such that the solar cell 18 is directed towards the barrier. In an embodiment where the solar cell is disposed on the exterior of the casing, the solar cell will be substantially sealed between the first barrier side 58, the spacer 20, and the second side of the base 16. In this way, the solar cell 18 is protected from moisture, dirt, or other debris that could compromise the function of the solar cell 18. Although the lighting apparatus is disposed entirely within the interior of the enclosure with no access to power generated externally of the enclosure, light energy is able to pass through the translucent portion 56 to reach the solar cell 18 and charge the rechargeable power storage apparatus 30.

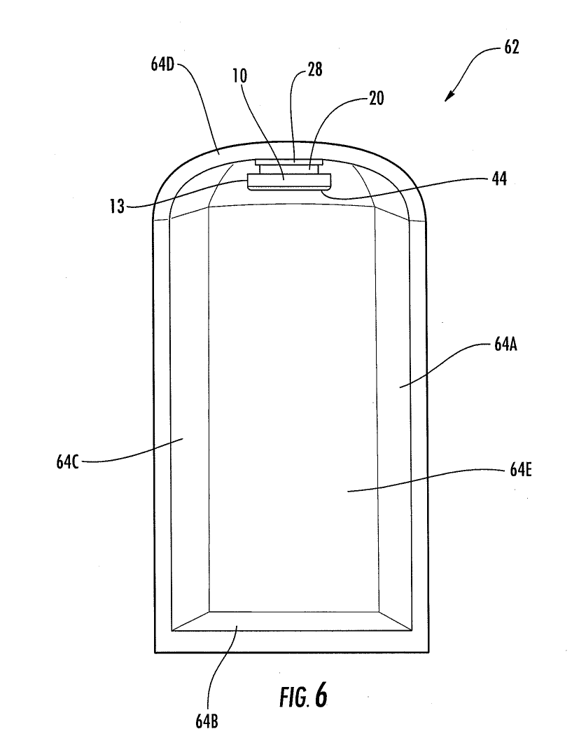

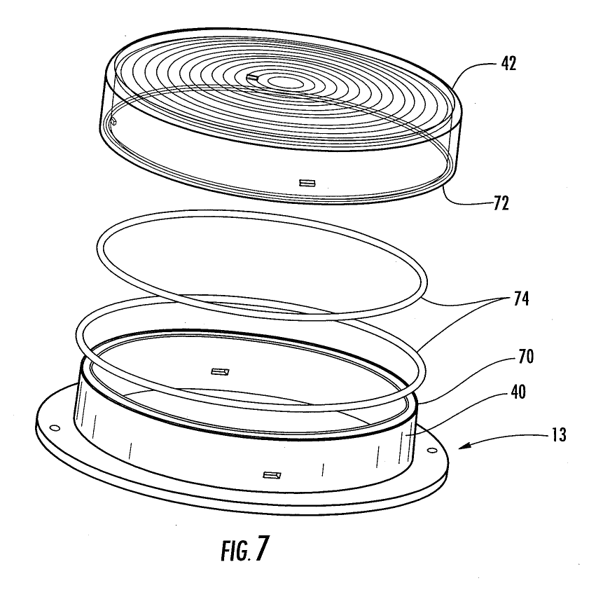

In a preferred embodiment shown in FIG. 6, another enclosure 62 is shown including a plurality of substantially nonporous and stiff barriers 64A, 64B, 64C, 64D, and 64E. In this case, the roof 64D of the enclosure is translucent. The roof barrier 64D includes a first barrier side 66 oriented toward an interior section 68 of the enclosure apparatus 62. The enclosure 62 further includes the lighting apparatus 10 shown in FIGS. 1-2 attached to the roof 64D in a manner similar to that discussed above with regard to FIG. 5.

The lighting apparatus 10 and variants thereof are preferably used in conjunction with small remote enclosures that include a translucent barrier or portion thereof such as, for example, a translucent roof or to retrofit such enclosures. Portable toilets are good examples of such structures, but not the only enclosure to which the lighting apparatus 10 may be applicable. Other structures including a translucent barrier or portion thereof include portable storage units, sales kiosks, portable food concession stands, parking booths, toll booths, and phone booths.

The foregoing description of preferred embodiments of the present disclosure has been presented for purposes of illustration and description. The described preferred embodiments are not intended to be exhaustive or to limit the scope of the disclosure to the precise form(s) disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the concepts revealed in the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

What is claimed is:

1. An autonomous lighting apparatus for use in an interior of an enclosure having a barrier including a translucent portion, the lighting apparatus comprising a casing including a base, the base including a first side and a second side; a solar cell configured to receive light energy directed toward the first side of the base; an adhesive disposed adjacent the first side of the base for attaching the first side of the base to an interior side of the translucent portion of the barrier; a rechargeable power storage apparatus electrically engaged with the solar cell; a light source electrically engaged with the power storage apparatus; and a detection device adjacent the second side of the base, the detection device electrically engaged with the power storage apparatus and configured to detect events occurring in the interior of the enclosure, such that upon the detection of such events the light source is activatable to illuminate the interior of the enclosure.

2. The lighting apparatus of claim 1 further comprising a removable liner covering the adhesive.

3. The lighting apparatus of claim 1 wherein the rechargeable power storage device further comprises a rechargeable battery.

4. The lighting apparatus of claim 1 wherein the light source further comprises a plurality of light emitting diodes.

5. The lighting apparatus of claim 1 wherein the detection device further comprises a light sensor capable of detecting changes in light levels.

6. The lighting apparatus of claim 5, wherein when the light sensor detects that ambient light levels have reached a threshold level, the light source is activated to illuminate the interior of the enclosure.

7. The lighting apparatus of claim 6, wherein when the light sensor senses a sudden change in light levels, the light emitted from the light source is increased.

8. The lighting apparatus of claim 5, wherein when the light sensor detects a sudden change in light levels, the light source is activated to illuminate the interior of the enclosure.

9. The lighting apparatus of claim 1 wherein the detection device further comprises an infrared sensor.

10. The lighting apparatus of claim 1 wherein the adhesive comprises a foam material having an average thickness ranging from about 0.25 inches to about 0.5 inches and an adhesive layer on both sides, a first adhesive layer adhering the foam material to the first side of the base and the second adhesive layer comprising a removable liner covering the adhesive.

11. The lighting apparatus of claim 1 further comprising a translucent or transparent cover attached adjacent the second side of the base for protecting internal components of the lighting apparatus.

12. The lighting apparatus of claim 8 wherein the lighting apparatus is substantially water-tight and an o-ring is disposed adjacent the interface between the base and the cover.

13. The lighting apparatus of claim 1, wherein the lighting apparatus has multiple modes of operation and further comprises a reed switch for toggling between the modes of operation by application of a magnet to adjacent the casing.

14. An enclosure comprising:
a plurality of barriers including at least one wall barrier and at least one roof barrier wherein at least a portion of one of the barriers is translucent, such barriers including an interior side and an exterior side; and
an autonomous lighting apparatus disposed within the interior of the enclosure, the lighting apparatus comprising a casing including a base, the base including a first side and a second side; a solar cell configured to receive light energy directed through the translucent portion of the barriers and toward the first side of the base; a rechargeable power storage apparatus electrically engaged with the solar cell; a light source electrically engaged with the power storage apparatus; and a detection device adjacent the second side of the base, the detection device electrically engaged with the power storage apparatus and configured to detect events occurring in the interior of the enclosure, such that upon the detection of such events the light source is activatable to illuminate the interior of the enclosure.

15. The enclosure of claim 14, wherein the enclosure is a portable toilet.

16. The enclosure of claim 14, wherein the lighting apparatus is adhered to a first translucent portion of the barriers.

17. The enclosure of claim 16, wherein the solar cell is disposed adjacent the interior side of the first translucent portion.

18. The enclosure of claim 14, wherein no aperture is disposed in the barriers for placement of the lighting apparatus.

19. The enclosure of claim 14, wherein the enclosure is a portable storage unit.

20. An method for retrofitting a portable enclosure to include a light source, the method comprising adhering a lighting apparatus to an interior side of a translucent portion of a roof without creating an aperture in the roof for placement of the lighting apparatus, the lighting apparatus comprising a casing including a base, the base including a first side and a second side, wherein the first side of the base is adhered to the translucent portion of the roof; a solar cell configured to receive light energy directed through the translucent portion of the roof and toward the first side of the base; a rechargeable power storage apparatus electrically engaged with the solar cell; a light source electrically engaged with the power storage apparatus; and a detection device adjacent the second side of the base, the detection device electrically engaged with the power storage apparatus and configured to detect events occurring in the interior of the enclosure, such that upon the detection of such events the light source is activatable to illuminate the interior of the enclosure.
